(19) United States
(12) Patent Application Publication
(10) Pub. No.: US 2013/0094801 A1
(43) Pub. Date: Apr. 18, 2013

(54) OPTICAL SPLITTER ARRAY

(71) Applicant: Terrel Morris, Garland, TX (US)

(72) Inventor: Terrel Morris, Garland, TX (US)

(73) Assignee: HEWLETT-PACKARD DEVELOPMENT COMPANY, L.P., Houston, TX (US)

(21) Appl. No.: 13/702,182

(22) PCT Filed: Jul. 2, 2010
(86) PCT No.: PCT/US2010/040980

§ 371 Date: Dec. 5, 2012

(51) Int. Cl. G02B 6/125

(52) U.S. Cl. CPC G02B 6/125
USPC 385/14; 427/163.2

(57) ABSTRACT

An optical splitter array can include a single branched waveguide core situated on a planar substrate and having an input optically connected to n outputs via n−1 splitters, where n is an integer of at least 2. The array can also include a single cladding layer overlying the single branched waveguide core from the input to the outputs, and a plurality of alignment channels aligned with the input and the outputs.

### BACKGROUND

Optical power splitters provide a manner of dividing an optical signal from an input to two or more outputs, or to replicate an input signal to two or more outputs. They are generally available in the form of joined fiber splitters, which include glass or plastic fibers that have been melted and joined to form a joint. In view of the demands of high capacity computing and other data transmission applications, there is interest in repeatable, consistent approaches for routing large numbers of optical signals.

### BRIEF DESCRIPTION OF THE DRAWINGS

FIG. 1 is a top view of a branched waveguide core with splitters in accordance with an embodiment of the present disclosure;

FIG. 2 is a top view of an optical splitter array in accordance with an embodiment of the present disclosure;

FIG. 3 is a cross section view of a portion of a clad branched waveguide core according to an embodiment of the present disclosure;

FIG. 4A is cross section view of optical fibers connected to an optical splitter array at the level of the alignment channels in accordance with an embodiment of the present disclosure;

FIG. 4B is a top view of the portion of the optical splitter array shown in FIG. 4B;

FIG. 5A is a perspective view of the input side of a stacked splitter array in accordance with an embodiment of the present disclosure; and

FIG. 5B is a side view of the output side of the stacked splitter array of FIG. 5A.

### DETAILED DESCRIPTION

Reference will now be made to the exemplary embodiments illustrated herein, and specific language will be used to describe the same. Features and advantages of the technology will be apparent from the detailed description which follows, taken in conjunction with the accompanying drawings, which together illustrate, by way of example, features of the technology.

It is to be noted that, as used in this specification and the appended claims, the singular forms “a,” “an,” and “the” include plural referents unless the context clearly dictates otherwise.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

The term “total internal reflection” refers to a property of a dense medium in which light traveling in the medium and hitting a medium boundary at a less-than-critical angle is completely or nearly completely reflected. With respect to an optics core as in an optical waveguide, total internal reflection is in reference to applicable industry standard acceptance cones for fiber optics.

The term “channel” refers to a structure or feature in a material that has a longitudinal inner space of a length and a width defined by the material, and which is configured to accommodate an optical waveguide or fiber and serve as a path to guide the direction and orientation of the fiber. Channels as used herein can include structures that are open only at each end, such as a tunnel, as well as structures that are open along at least part of their length, such as a groove or trough.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Embodiments are described herein that are exemplary of optical splitter arrays that comprise a planar substrate on which a single branched waveguide core is situated, where the core has an input and n outputs optically connected to the input via n−1 splitters. In these embodiments, n is an integer of at least 2. The optical splitter arrays further comprise a single cladding layer overlying the single branched waveguide core from the input to the outputs, and a plurality of alignment channels aligned with the input and the outputs.

In more particular embodiments, the optical splitter array can further comprise optical fibers optically connected to any of the input and the corresponding outputs. The optical waveguides or fibers are situated in the alignment channels, and thereby aligned with the input and the outputs.

Embodiments herein also include methods of making optical power splitter arrays, comprising a plurality of steps. The steps of the method can comprise forming a planar substrate and placing a forming structure thereupon. The forming structure includes a branched cavity including an input end and n output ends connected to the input end via including n−1 bifurcations, where n is an integer of at least 2; and a plurality of alignment features each aligned with the input end and output ends. The steps of the method also comprise filling the branched cavity with a core material to form a single branched waveguide core on the substrate. The single branched waveguide core has a corresponding configuration, i.e. an input and n outputs optically connected to the input via n−1 splitters. This use of the forming structure also forms an alignment channel aligned with at least an output end and from which core material is excluded. The method further comprises depositing a single cladding coating on the single branched waveguide core; and connecting an optical fiber to one of the outputs by inserting the optical fiber into one of the alignment channels.

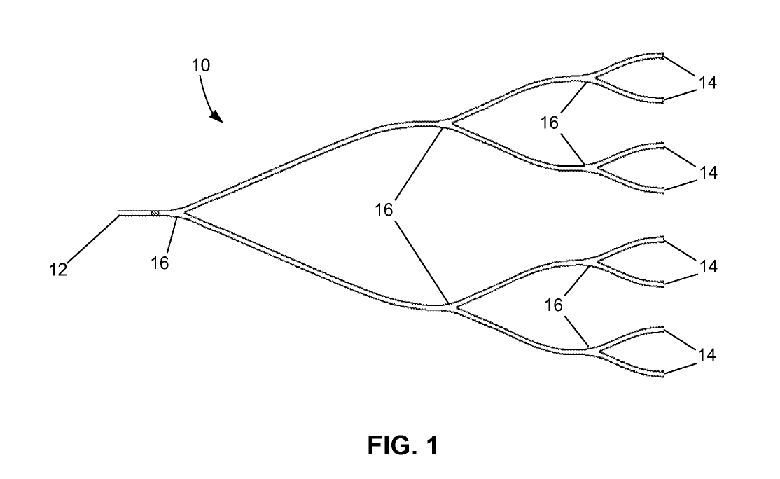

A waveguide network in accordance with embodiments herein can include a single branched waveguide core 10 as illustrated in FIG. 1, in which an input 12 is split into a plurality of outputs 14 by the inclusion of splitters 16. In a particular aspect, the splitters are binary splitters presenting bifurcations in the light path. In a more particular aspect, the binary splitters are 50:50 splitters, i.e. that each provides a substantially equal division of an optical signal entering the splitter. Each binary splitter in the network creates an additional path. Accordingly, one aspect of the array is that n outputs arise from the inclusion of n−1 splitters in the array, wherein n has an integer value of 2 or greater. In another aspect, the network is arranged as a binary tree, i.e. having a plurality of levels of splitters where each splitter bifurcates the light path. An example of such an arrangement is shown in FIG. 1, where the network is a complete binary tree, i.e. each path bifurcates at each level, so that the 7 splitters provide a 1:8 input-to-output structure.

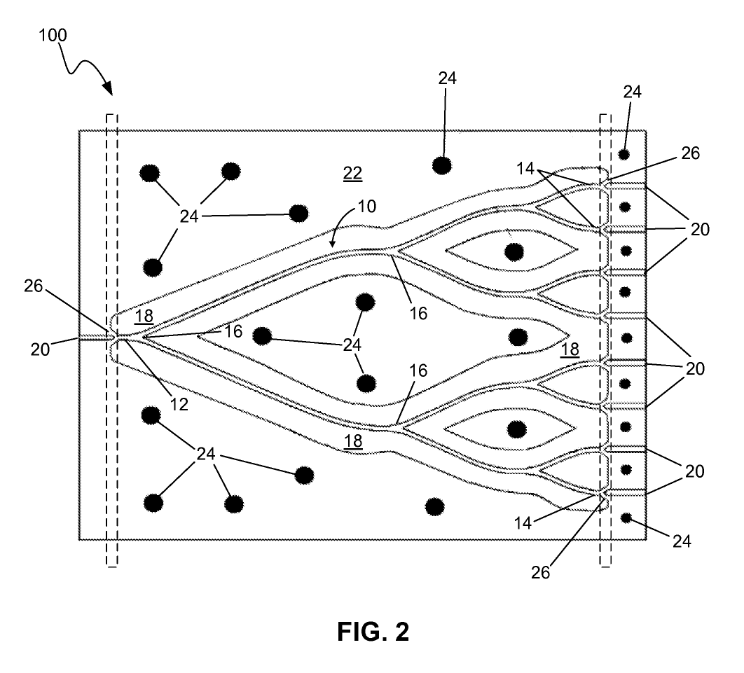

In an embodiment as shown in FIG. 2, an optical splitter array 100 comprises a branched waveguide core 10 disposed on a substrate 18. The substrate is made of a material suited for optical applications as are conventional in the art. In particular, the substrate can be a material suited for support of waveguides and suited to impart desired qualities to the substrate, i.e. to provide desired flatness, internal reflection, thermal properties, stiffness, and the like. In a particular example, the substrate comprises a metal. In another example, the substrate comprises a clad glass. Other examples of material choice include metalized ceramic or metalized plastic substrates. More particularly in one embodiment, the substrate can include a cladding layer that contributes to light containment, particularly a reflective metallic cladding material. In one specific example, the planar substrate has an aluminized mylar coating,

In one aspect, the substrate 18 employed is substantially planar. Techniques for synthesizing and planarizing optical substrates include epitaxy, layer growth, lithography, photolithography, evaporative deposition, sputtering, vapor deposition, chemical vapor deposition, beam deposition, beam-assisted deposition, ion beam deposition, ion-beam-assisted deposition, plasma-assisted deposition, wet etching, dry etching, ion etching (including reactive ion etching), ion milling, laser machining, spin deposition, spray-on deposition, electrochemical plating or deposition, electroless plating, photo-resists, UV curing and/or densification, micro-machining using precision saws and/or other mechanical cutting/shaping tools, selective metallization and/or solder deposition, and chemical-mechanical polishing.

In accordance with the embodiment, the network is provided by a single branched waveguide core 10. That is, the branches and splitters of the array from input side of the array to the output side are all formed from a single waveguide core. In an embodiment, the single waveguide core is shaped into all of the branches and splitters of the array as a single fabrication step. Materials known for use as waveguide cores can be used as core material in accordance with embodiments of the present disclosure. In particular, the core material can comprise a glass, or alternatively, a polymer such as polycarbonate, particularly polymers amenable to heat-based or ultrasonic forming methods.

According to an embodiment herein, the branched waveguide core 10 can be formed by using a forming structure to shape core material on the planar substrate 18, where the forming structure is configured according to the intended arrangement of the network. For example, the forming structure can be a mold structure comprising a branched cavity shaped so as to correspond to the desired arrangement of the network. In a more specific example, the branched cavity can have an input end connected to a plurality of output ends by a branching network of bifurcations. The branched waveguide core can be formed by positioning the forming structure on the substrate and filling the cavity with core material to make a core the shape of the cavity. In a particular aspect, the core material is liquefied before or during formation, and then cured to form a solid waveguide core.

The general process described herein can be accomplished in more particular embodiments using material forming techniques. In one embodiment, the core can be made by an injection molding process, with an injection mold as the forming structure. In an example of this, the injection mold having a branched cavity is placed against the planar substrate so as to seal the cavity. Liquid core material is then injected into the cavity and cured by cooling or other means to create the waveguide form.

In another embodiment, a compressive molding process can be utilized, where the forming structure is a compression mold having a mold cavity such as described above, For example, liquefied core material can be placed in the open mold cavity, or alternatively placed directly onto the planar substrate 18, e.g. as a sheet. The mold is then placed against the substrate, and pressure and energy are applied so that the core material melts and assumes the form of the cavity. In a compressive thermal process, heat is applied to melt the core material. Alternatively, in a compressive ultrasonic process, the core material is melted by the application of ultrasound.

While the forming methods described above are representative of fabrication methods that can be used in accordance with the general embodiment, it should be noted that other techniques and approaches known in the art for general fabrication tasks can also be used. Thus, other similar techniques or methods as those described herein can be used as would be known by one skilled in the art after considering the present disclosure.

Connectivity with the optical splitter array can be provided by connecting optical fibers to the input 12 and outputs 14 of the waveguide core 10. The optical fibers can be aligned with the input and outputs to achieve signal transmission with reduced coupling loss. However, fiber to waveguide alignment can be quite challenging at a single coupling, and even more so at multiple outputs or inputs. The arrays and methods described herein provide alignment channels 20, each aligned with an input or output of the array and configured to receive and hold an optical fiber in alignment with an input or output. In a particular embodiment, the alignment channels are fabricated and placed as part of the same step in which the waveguide core is formed. In this way, alignment of optical fibers to inputs or outputs of the waveguide core can be achieved at multiple couplings in a consistent fashion, as the alignment channels are made through a common process with the core rather than through a separate and subsequent addition step.

In an example, the forming structure used to make the branched waveguide core 10 also includes alignment features aligned with the input end and output ends of the mold cavity. The alignment features are configured so that their presence during core formation also results in the formation of an alignment feature already aligned with the core input 12 or output 14. In a particular example, an alignment feature is a protuberance on the mold surface adjacent the mold cavity. The protuberance is placed so that when core material is introduced into the cavity, the protuberance excludes the core material in a pattern so as to define a groove in the core material that is aligned with an input or output. After curing and removal of the forming structure, the groove serves as a structure into which an optical fiber 30 can be inserted for alignment and coupling with the input or output.

FIG. 2 also shows a molded sheet 22 of core material in which the branched waveguide core 10 is defined, as well as alignment channels 20 (shown as grooves in this example) from which core material is substantially absent. Other features of the forming mold can also displace core material. In the example shown, the substrate 18 is visible adjacent to the core, due to the displacement of core material by contours of the mold that define the mold cavity.

Sprues 24 are also noted, as resulting from the vents that allow either the entrance of material in the case of injection molding, or the exit of excess material in the case of compressive thermal or ultrasonic forming. Also shown are temporary bridges 26 of core material. These are molded as a result of pathways placed in the mold to allow the flow of core material around the protuberances that form the alignment channels.

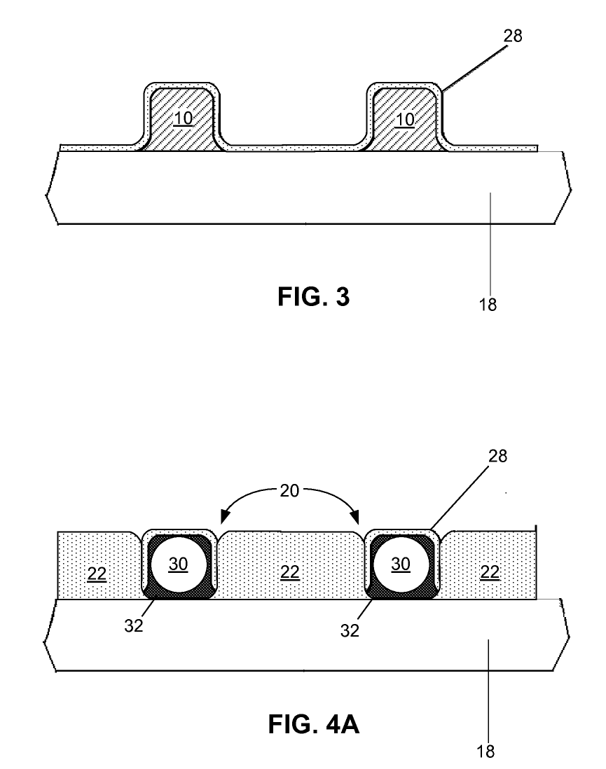

After forming the waveguide 10 and alignment channels 20 of the array, the array can be removed from the forming structure. A metal or metallized cladding coating 28, as shown in FIG. 3, can be added to the waveguide core to provide light containment at the exposed surfaces of the core. In another aspect, the cladding coating can be made of a material having an index of refraction substantially different than that of the core. As discussed herein, the optical array can comprise a single branched waveguide core 10, as shown in FIGS. 1 and 2, and further the single branched waveguide core can be fabricated as a single step. Accordingly, the core can also be clad in total in another single step.

In a particular embodiment, as shown in cross-section in FIG. 3, a single cladding coating 28 is applied to the entire branched waveguide core 10 on substrate 18. An aspect of this arrangement is that all of the path segments as well as all of the splitter joints can be clad with a single coating. Conventional approaches often involve post-cladding assembly of a splitter network, where individual clad waveguides are joined to form splitters. This can result in unclad splitter joints and a consequent loss of light containment. However, in accordance with the present devices and methods, a uniform cladding can be present on the entire core from the input to the outputs, and thereby provide light containment over the whole light path. In a particular embodiment, the single branched waveguide core utilizes total internal reflection at all points along a path of an optical signal from the input to the outputs for purposes of signal containment. The optical array as described herein can transmit and split an optical signal input while exhibiting little to no loss of containment.

The cladding coating 28 can be applied by techniques known in the arts, including spraying, immersion, or sputtering. The cladding coating can comprise any material known in the art for providing or improving light containment in waveguides. The cladding coating can also be chosen serve to provide a mechanical constraint against thermal expansion of the core. For example, a metal cladding coating having a lower coefficient of thermal expansion (GTE) can be used to coat a polymer waveguide core having a higher CTE.

The splitter array can undergo further processing steps, such as the removal of excess material. For example, referring again to FIG. 2, the temporary bridges 26 of core material obstruct the path between the alignment channels 20 and the waveguide outputs 14 and input 12. In one aspect therefore, a further step can comprise removing bridge material from around the input and outputs and the alignment channels. This step provides access to the waveguide end so that an optical fiber in the alignment channel can be coupled to the waveguide end. This can also serve to form a planar surface at the end of each waveguide. In a particular example, a cut, a cut and polish, an ablation, or other material removal step is employed to create two channels that intersect the bridges. In a more particular example, the channels are straight parallel lines, allowing any cutting, polishing, ablation, or other material removal operation to be performed by automated equipment in a short amount of time and with little additional handling or positioning. An extent of such a cut is indicated in FIG. 2 by the dashed outline.

An aspect of an embodiment is that the optical arrays are stackable structures. Accordingly, further processing steps can be included to planarize a surface of the array and thereby provide stackability. More specifically, the upper surface of the array is processed so as to impart a planar character to that surface so that both the bottom (substrate) surface and the upper surface are substantially planar. In a particular example, another processing step can include removal of any sprues or flash left by the molding process. In another example, further processing can include any other ablations, cuts, or polishes that impart a desired profile to other edges or surfaces of the array.

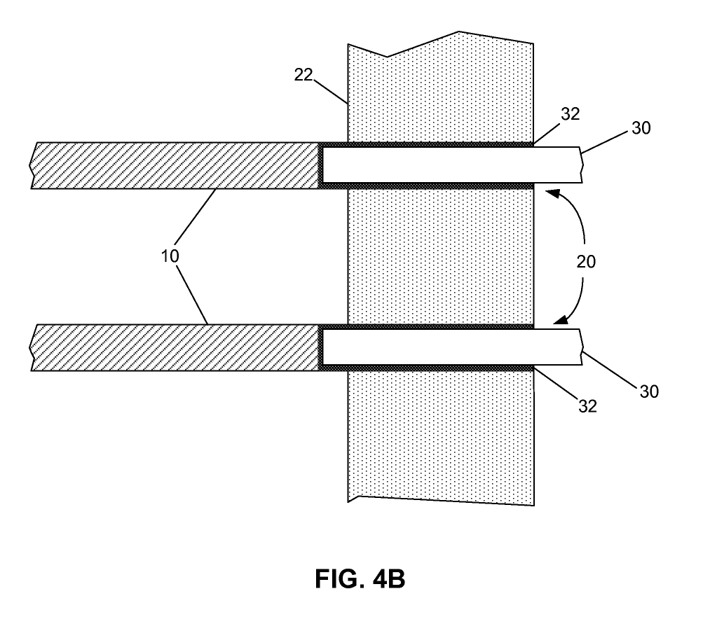

Optical fibers can be added to the splitter array to carry optical signals into and out of the array. In an embodiment as illustrated in FIGS. 4A-4B, an optical fiber 30 is coupled to a waveguide by inserting the fiber into the alignment channel 20 that is aligned with the adjacent end of the waveguide core. The fiber is inserted further until the end of the fiber is then butt-coupled to the waveguide. In a more particular embodiment, coupling can be facilitated by introducing an index matching material 32 at the joint, e.g. between the fiber and waveguide, so as to avoid refractive index mismatches between the respective materials used as well as eliminate any air-filled voids at the interface. In one example, the fiber end is dipped into an index matching material before being inserted into the alignment feature. Any index matching oils, polymer gels, or other materials known in the art are contemplated for use. The particular material can be selected based on its refractive index and the refractive indices of the waveguide and fiber core materials. In a still more particular embodiment, the index matching material is an adhesive epoxy that can be cured to secure the fiber in place.

In accordance with the embodiments herein, planar optical power sputter arrays can be manufactured in volume with a high degree of consistency repeatability across splitters and outputs. This is at least in part due to enhanced control over splitter structure, allowing predictable and consistent performance across all of the splitters of the array. One aspect of this feature can be provided by utilizing consistent splitting angles across splitters. The present methods provide a way of attaining a level of consistency not possible with methods using one-off splitter fabrication and subsequent assembly. In a particular example, the splitting angles of the n−1 splitters exhibit a standard deviation of less than about one percent. In another example, the splitting angles of the n−1 splitters in an array are equal.

It will be understood by those skilled in the art that the specific geometries of each splitter can be tailored as required for the wavelength of light supplied as well as the intended application of the device. For example, splitter angles can range from extremely shallow angles to angles in excess of 45 degrees. Likewise, the waveguides at the split can be locally widened or narrowed as required to provide best performance in the intended application. In some applications, it may be advantageous to form a circle, square, triangle, or other shape of core material locally at each split in order to best control the division of optical power for the intended wavelength of light and end use of the splitter device, While this localized shape modification allows tuning to specific applications, it is intended to facilitate optimization and does not depart from the structure and method taught elsewhere in this application.

In another aspect, the consistency of splitter structure provides consistent power distribution among splits and within splitter levels in a network; that is, it is possible with the described arrays to split a signal into multiple outputs where the power is evenly distributed among those outputs. In a particular embodiment, the ratio of optical signal power between input and all collective outputs is equal across the outputs. It should be understood, that the array can be arranged so as to yield outputs of different power, for example by providing light paths are split more or fewer times than others. However, even in such an arrangement, the present embodiments can provide even power distribution among all outputs that arise from an equal number of splits.

In addition, the embodiments provide the ability to aggregate a large number of optical power splitters in a very small planar form factor. The methods described herein provide a means to fabricate optical splitter arrays having 4 or more outputs for each input. In a particular aspect, a single optical splitter array according to the embodiments herein can include from 4 to 16 outputs for each input.

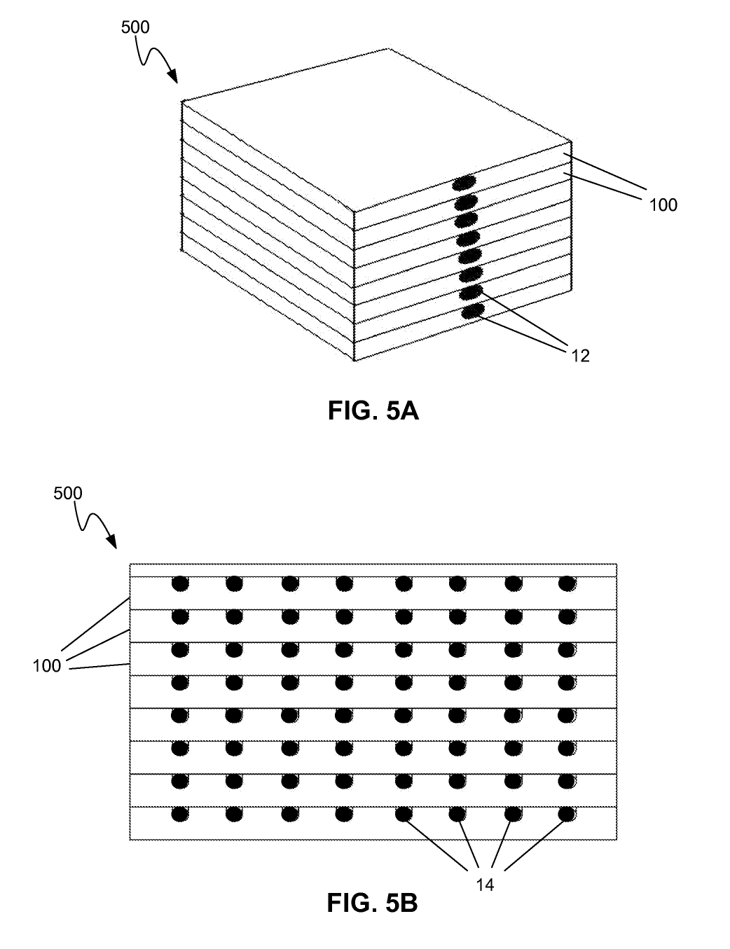

The planar form makes it possible to stack multiple arrays in a compact package, thereby creating high bandwidth multi-in/multi-out parallel splitter solution, e.g. for use in optical networks or data buses. In one example, it can be desirable to achieve large numbers of replicated splits for certain computer architectures. In an embodiment as shown in FIGS. 5A-5B, a stacked optical splitter array 500 can comprise a plurality of optical arrays 100 in a stacked configuration. FIG. 5A shows the input 12 side and the output 14 side is shown in FIG. 5B. FIGS. 5A-5B show eight 1:8 optical arrays stacked to form an 8:64 splitter, i.e. with eight inputs and 64 outputs. It should be noted that the stacked arrays can be packaged in plastic, metal, glass, or other casings as desired for ease of handling, installation, or other use. Where the stack is further packaged in a casing, the casing can include holes to accommodate incoming and outgoing optical fibers.

It should be noted that the modular nature of the optical array allows for different ordering of some steps in assembly. For example, with some uses it may be convenient to stack arrays (and optionally package them further) before coupling optical fibers with the waveguides. In such cases, the stacking or packaging can provide stability that eases insertion of fibers into the alignment channels 20, shown in more detail in FIGS. 4A-4B. In other uses the optical fibers can be added to the array before further assembly of stacks.

The stacking of multiple-output splitters provides a way to connect a single fiber ribbon input to multiple fiber ribbon outputs. In particular, inputs 12 and outputs 14 can be presented in a dense and uniform two-dimensional array that can be specified to match other input/output structures. For example, an array as shown in FIGS, 5A-5B can be used to interface with eight 8-channel ferrules connected to ribbon cables or other such structures. In a particular example, the ferrules can each be connected to a single array, i.e. stacked vertically with reference to the orientation shown in FIGS. 5A-5B, to split a single input within the ferrule. Alternatively the ferrules can be connected across arrays, i.e. stacked horizontally with reference to FIGS. 5A-5B, so as to each carry optical signals from multiple inputs.

Summarizing to an extent, a method has been developed for making planar optical splitter arrays having multiple splitters and consistent outputs, An example of such a method of making an optical power splitter array can comprise a step of forming a planar substrate, and a further step of placing a forming structure on the substrate, where the forming structure includes a branched cavity including an input end and n output ends connected to the input end via including n−1 bifurcations, where n is an integer of at least 2. The forming structure can also comprise a plurality of alignment features aligned with the input end and output ends. A further single step includes forming a single branched waveguide core and alignment channels on the substrate. In a particular embodiment, the forming step can comprise filling the branched cavity with core material to form the waveguide core. The alignment features exclude core material to form alignment channels aligned with the input and output ends. The method can further comprise a step of depositing a single cladding coating on the single branched waveguide core.

In a particular embodiment, further processing can be applied to the optical power splitter array. More particularly, processing can include cutting, polishing, ablation, or other material removal operations as described above. In a specific embodiment, processing includes removing core material from between an output and an alignment channel. In another specific embodiment, the processing step includes planarizing a surface of the optical power splitter array.

A particular embodiment of the method can further comprise connecting an optical fiber 30 to one of the outputs by inserting the optical fiber into an alignment channel. A more particular embodiment can include an optional step can comprise applying an index matching material between the end of optical fibers and the input or outputs to which they are connected.

The optical splitter arrays are stackable, allowing high density packaging of multiple power splitters that can be used in high-throughput data applications. Accordingly, a plurality of optical power splitter arrays made by the above method can be stacked to form a stacked splitter array. In a particular embodiment, optical fibers can be connected to the arrays after stacking.

While the forgoing exemplary embodiments are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the principles and concepts of the technology be limited, except as by the claims set forth below.

1. An optical splitter array, comprising:
a planar substrate;
a single branched waveguide core situated on the planar substrate and having an input and n outputs optically connected to the input via n−1 splitters, wherein n is an integer of at least 2;
a single cladding layer overlying the single branched waveguide core from the input to the outputs; and
a plurality of alignment channels aligned with the input and the outputs.

2. The optical splitter array of claim 1, further comprising optical fibers optically connected to the input and one of the outputs and situated in the alignment channels, and thereby aligned with the input and the outputs.

3. The optical splitter array of claim 1, wherein a ratio of optical signal power between the input and all collective outputs is equal.

4. The optical splitter array of claim 1, wherein the single branched waveguide core utilizes total internal reflection at all points along a path of an optical signal from the input to the outputs for purposes of signal containment.

5. The optical splitter array of claim 1, wherein splitting angles of the n−1 splitters exhibit a standard deviation of less than about 1 percent.

6. The optical splitter array of claim 1, wherein n equals an integer from 4 to 16.

7. The optical splitter array of claim 1, wherein the plurality of optical fibers are optically connected to at least the input and one of the outputs via an index matching material.

8. A stacked splitter array, comprising a stack of the optical arrays of claim 1.

9. A method of making an optical power splitter array, comprising:
forming a planar substrate;
placing a forming structure on the planar substrate, said forming structure comprising:
a branched cavity including an input end and n output ends connected to the input end via including n−1 bifurcations, wherein n is an integer of at least 2; and
a plurality of alignment features each aligned with the input end and output ends;
filling the branched cavity with a core material to form on the planar substrate a single branched waveguide core having an input and n outputs optically connected to the input via n−1 splitters and form an alignment channel aligned with an output end and from which core material is excluded; and
depositing a single cladding coating on the single branched waveguide core.

10. The method of claim 9, further removing core material from between an output and an alignment channel.

11. The method of claim 9, further comprising planarizing a surface of the optical power splitter array.

12. The method of claim 9, further comprising connecting an optical fiber to one of the outputs by inserting the optical fiber into one of the alignment channels.

13. The method of claim 12, wherein the connecting step includes placing an index matching material between an end of the optical fiber and the output.

14. A method of splitting an optical signal, comprising sending an optical signal into an input of an optical splitter array and receiving the optical signal at n outputs, said optical signal being split at n−1 splitters, where n is an integer of at least 2, said optical splitter array comprising a single branched waveguide core 10 situated on a planar substrate, and a single cladding coating overlying the single branched waveguide core from the input to the outputs, wherein the single branched waveguide core utilizes total internal reflection at all points along a path of an optical signal from the input to the outputs for purposes of signal containment, and wherein a ratio of the power of the optical signal between the input and all collective outputs is equal.

15. The method of claim 14, further comprising forming a plurality of alignment channels aligned with the input and the outputs.
